(19) United States
(12) Patent Application Publication
(10) Pub. No.: US 2012/0204669 A1
(43) Pub. Date: Aug. 16, 2012

(54) SHIFTING DEVICE FOR A MULTI-GROUP TRANSMISSION

(75) Inventors: Reinhard Birk, Wasserburg (DE); Jochen Heinzelmann, Meckenbeuren (DE)

(73) Assignee: ZF FRIEDRICHSHAFEN AG, Friedrichshafen (DE)

(21) Appl. No.: 13/502,576

(22) PCT Filed: Oct. 13, 2010
(86) PCT No.: PCT/EP2010/065299

§ 371 Date: Apr. 18, 2012

(30) Foreign Application Priority Data
Nov. 3, 2009 (DE) 10 2009 046 345.3

(51) Int. Cl. F16H 59/02

(52) U.S. Cl. 74/473.36

(57) ABSTRACT

A shifting device for a multi-group transmission having a manual main group with an odd number of forward gears and a range group for shifting between two gear ranges. A shift finger system and a logical shifting pattern for shifting the transmission with and without a range change. The system comprises single shift fingers and possibly double shift fingers which are located in a plane and offset from one another. Carrier elements are associated with the shift fingers, by which the carrier elements can be optionally actuated in two opposite shifting directions and/or a particular shifting direction can be reversed, so that the gears of the two gear ranges can be actuated in a multiple-H shifting pattern in sequence by alternating shift lever movements, and a shift of the gear range can be produced by a selection movement of the shift lever.

This application is a National Stage completion of PCT/EP2010/065299 filed Oct. 13, 2010, which clams priority from German patent application serial no. 10 2009 046 345.3 filed Nov. 3, 2009.

### FIELD OF THE INVENTION

The invention concerns a shifting device for a multi-group transmission.

### BACKGROUND OF THE INVENTION

In motor vehicles with variable-speed transmissions, shifting devices with so-termed H-shaped shifting patterns for operating the transmission with a shift lever have proved successful. Such shifting patterns, with gears at least approximately opposite one another in shift gates, are shown by experience to be intuitively grasped by the driver and perceived as logical. Basically, with increasing numbers of gears there can be single-H, double-H or multiple-H shifting patterns. However, as the number of gears increases their technical realization becomes more complex since, depending on the structure of the transmission, successive gears in a shifting gate may be actuated both by means of the same, and also by means of different shifting packets which as a rule are formed of shifting sleeves and synchronizing rings. This requires conversion means by which, when a gear is disengaged by moving a shift lever in a shifting gate, a particular shifting packet is actuated, whereas when a new, gear opposite it is engaged by moving the shift lever in the opposite direction within the same shifting gate, another shifting packet is actuated.

Such a multi-gear transmission with a mechanical conversion device is known from DE 102 53 471 A1. In it, a shift lever is coupled to a shift finger shaft which can be moved axially and rotated about its longitudinal axis. The shift finger shaft passes through an opening of shifting frames or carrier elements connected to shifting rods. At their free end, the shifting rods are connected to shifting forks which engage in sliding sleeves of shifting packets.

On the shift finger shaft is arranged at least one shift finger for each carrier element, each carrier element having at least one recess. The shift fingers are connected to the shift finger shaft as cam-like radial projections. The recesses of the frame-shaped carrier elements each have a straight side as a shifting contour in the gear engagement direction and a curved side as a free-movement contour opposite to the gear engagement direction. During a gearshift the disengagement of the engaged gear by corresponding movement of the shift lever in the current shifting gate results, with the help of the associated carrier element, in the disengagement of the gear in the transmission.

To shift through to the next gear in the same shifting gate, in parallel with this a farther rotation of the shift finger shaft in the same rotational direction takes place, which brings about the engagement of the gear in the transmission with the help of a second carrier element. Depending on the gearshift concerned, the two carrier elements involved can move in the same shifting direction, i.e. both to the right or both to the left, or in different shifting directions, i.e. one carrier element to the right and the other carrier element to the left. In the latter case, the shift finger system functions as the conversion device. By virtue of a suitable arrangement and orientation of a particular number of shift fingers on the shift finger shaft, the number corresponding to the number of transmission gears, depending on the gear structure, although it can also be smaller, and with one carrier element for two gears in each case, only one shift finger shaft is needed to obtain an H-shifting pattern, for example of a dual-clutch transmission with six or seven forward gears and one reverse gear.

Basically, in the case of multi-group transmissions, H-shifting patterns are already known for a manual shift system of the transmission. Transmissions of group design with a main group and sometimes an upstream splitter group of countershaft design and an upstream or downstream range group, usually of planetary design, are used particularly in utility vehicles which need a relatively large number of gear steps. Usually, the range group enables a shift between two gear ranges since the planetary transmission rotates as a block or one of its components is fixed. The range group can be shifted by a transmission control unit by hydraulic or pneumatic actuation of appropriate shifting elements. The splitter group enables shifting between two input constants. The splitter group is also shifted hydraulically or pneumatically. As a rule the total number of gears is determined by the number of gears of the manually shifted main group. In the group transmissions available nowadays this has either three or four gear steps, so that 6-gear or 8-gear or 16-gear transmissions are obtained.

In the case of multi-group transmissions having a manually shifted part as the main group with an even number of forward gears, double-H shifting patterns and superimposed-H shifting patterns are already known. In a double-H shifting pattern such as that described in DE 10 2007 046 737 A1, the gear ranges are shifted by a selection movement of the shift lever in the selection direction. In a superimposed-H shifting pattern, i.e. with two H-levels superimposed one over the other, shifting of the gear range, i.e. of the range group, takes place by means of an additional operating element such as a pre-selector switch on the shifting knob of the shift lever, or automatically by means of a control unit assisted by rotational speed sensors, as described for example in DE 10 2007 024 793 A1. This avoids the risk of shifting errors in frequent range shifts that follow one another at short intervals, caused by forgetting to actuate the pre-selector switch, and increases the shifting comfort.

In contrast, in the case of multi-group transmissions having a manually shifted part with an odd number of forward gears, until now only superimposed-H shifting patterns have been known. In such cases, in addition to the rather bothersome and uncomfortable manual, or relatively complex automatic H-level shifting, for the driver the shifting pattern seems rather illogical since in at least one shifting process for a gearshift between two successive gears, the shift lever has to be moved through two shifting gates in the same shift lever direction. Those familiar with the field will also find in the documents mentioned earlier no indication of how to circumvent this in a group transmission with an odd number of gears in its manually shifted part.

Furthermore, in the transmissions of today the available fitting space is increasingly restricted, with regard to the overall axial length of the shift finger systems, and in the design of conversion devices in shift systems this must be taken into account.

### SUMMARY OF THE INVENTION

Against this background the purpose of the present invention is to provide a shifting device for a multi-group transmission having a manually shifted main group with an odd number of forward gears and a range group by means of which the manually shifted part can be switched between two gear ranges, which enables comfortable and simple operation with a logical shifting pattern of the gears available by virtue of the manually shifted part with range shifting, and which has a compact structural form.

The invention is based on the recognition that in a group transmission with an odd number of forward gears in its manually shifted part and a shiftable range group, with the help of suitably designed and orientated shift fingers and associated carrier elements with a plurality of engagement possibilities, a variability of shifting actuation with the necessary conversion of the shift direction and the activation of common and different shifting packets of the gears can be achieved, which is such as to enable a shifting device which the driver can operate comfortably with a logical movement sequence for shifting through the gears.

Accordingly, the invention starts from a shifting device for a multi-group transmission, the multi-group transmission comprising at least one manually shifted main group with an odd number of forward gears and a range group for shifting between two gear ranges, with a shift lever with which a shifting pattern is associated, which comprises a selector gate and a plurality of shifting gates with gears opposite one another, by virtue of which a shift finger shaft carrying a plurality of shift fingers can be swiveled about its longitudinal axis and can be moved axially, so that, depending on the movement of the shift lever, to shift a gear a shift finger engages in an associated carrier element in order, by way of a shifting rod, to actuate a shifting packet coupled to the carrier element in an appropriate shifting direction, and with mechanical means for reversing the shifting direction and for shifting gears that are opposite one another in a shifting gate and that are controlled by different shifting packets.

To achieve the stated objective, the invention provides a shift finger system consisting of shift fingers designed as single shift fingers having one finger element each and, where necessary, as double shift fingers each having two finger elements arranged in a plane but offset relative to one another, and consisting of associated carrier elements that have corresponding recesses for engaging the single shift fingers and where necessary the double shift fingers, by means of which the carrier elements can be selectively actuated in two opposite shifting directions and/or a particular shifting direction can be reversed, so that the gears of the two gear ranges can be engaged in a multiple-H shifting pattern, in sequence, by alternating shift lever movements, and the gear range can be shifted by means of selection movement of the shift lever.

A multiple-H shifting pattern is understood to be a pattern in which the basic H shape, which has two vertical shifting gates and a horizontal selector gate, is extended by two or more vertical shifting gates, such that the term multiple-H shifting pattern also includes a double-H shifting pattern.

By virtue of the shift finger system according to the invention a double-H or multiple-H shifting device is provided, in particular for a 6-gear or 12-gear group transmission with three synchronized forward gears in the main transmission, so that easy and comfortable shifting through the gears without shift gaps is possible.

Two shifting pattern variants have been found to be particularly advantageous, in which the range shift in each case takes place automatically between the third and fourth gear with a movement of the shift lever in the selection direction. In this case the fourth gear corresponds to the first gear, the fifth gear to the second gear and the sixth gear to the third gear, with respective alternatively engaged range groups. If an additional splitter group is provided, then by means of a separate operating element each of these six gears can again be stepped down in an intermediate stage so that a total of 12 gears are obtained.

With such an existing transmission, according to the invention a first shifting pattern can be provided in which, in a first shifting gate, a reversing gear and a first forward gear can be engaged by means of a common shifting packet, after a first selection movement of the shift lever into a second shifting gate a second forward gear and a third forward gear can be engaged by means of a common shifting packet, after a second selection movement of the shift lever with a range shift and a shifting direction reversal in a third shifting gate a fourth forward gear and a fifth forward gear can be engaged by means of different shifting packets, and after a third selection movement of the shift lever into a fourth shifting gate a sixth forward gear can be engaged.

Advantageously, this can be done with a shift finger system in which a first carrier element acts upon the first and fourth gears and the reverse gear and a second carrier element upon the second, third, fifth and sixth gears, a double shift finger being provided in each case for the first and second shifting gates and a total of three single shift fingers for the third and fourth shifting gates.

The shift fingers can be in the form of rings fixed on the shift finger shaft, which are connected integrally to their finger elements, the finger elements projecting like studs radially outward. The associated frame-like carrier elements have circular or nearly circular openings for holding the shift finger shaft, in which the recesses are designed to engage the finger elements.

Advantageously, each carrier element has four recesses for a double shift finger, such that two pairs of recesses are positioned opposite one another respectively above and below a displacement axis of the carrier element. Adjacent recesses in the carrier element can be separated by a radially inward extending, elongated, tooth-like projection, this projection being acted upon in the gear engagement direction by the finger element concerned and moving freely in the direction opposite to gear engagement.

When the double finger engages in one or the other recess pair, rotation of the shift finger shaft to the right or to the left moves the carrier element in one or the other shifting direction. Accordingly it is provided that by means of a double shift finger, on the one hand the carrier element can be moved to the right or to the left, and on the other hand, if the double shift finger is correspondingly oriented by rotation so as to change its engagement from below to above, with the same rotational direction of the shift finger shaft the carrier element can conversely be moved to the left or to the right. This arrangement provides the greatest possible flexibility for action upon the carrier elements and hence upon the respective shifting packets.

In contrast, to bring about only one shifting direction reversal, it is sufficient to have a combination of one lower and one upper recess, so that depending on the orientation of the respective single finger in each case only one shifting direction is possible.

Thus, by axial displacement and rotation of the shift finger shaft, depending on the shifting and selection movement of the shift lever the carrier elements are moved in one or the other shifting direction, the shifting direction is reversed, or a neutral position is adopted. To ensure that a free carrier element is not moved unintentionally, a neutral finger can also be provided to secure the neutral position of the carrier element in the disengaged condition.

With this shifting pattern a particularly compact design can also be produced with a shift finger system in which there are provided, for the first and second shifting gates, single shift fingers that in the actuation position extended perpendicularly to a displacement axis of the carrier element and are arranged under the displacement axis for engagement from below, and for the third and fourth shifting gates a total of three shift fingers that in the actuation position extend obliquely to the displacement axis of the carrier element and are arranged above the displacement axis for engagement from above, such that preferably the upper engagement has a free movement section delimited by a suitable contour.

A second logical shifting pattern in a group transmission can be obtained in that, in a first shifting gate a reversing gear is engaged, after a first selection movement of the shift lever with a shifting direction reversal in a second shifting gate, a first forward gear and a second forward gear can be engaged by means of different shifting packets, after a second selection movement of the shift lever in a third shifting gate, a third forward gear can be engaged, after a third selection movement of the shift lever with a range shift in a fourth shifting gate, a fourth forward gear can be engaged, and after a fourth selection movement of the shift lever in a fifth shifting gate, a fifth forward gear and a sixth forward gear can be engaged by a common shifting packet. A corresponding shift finger system comprises for the fifth shifting gate a double shift finger and for the other four shifting gates a total of five single shift fingers.

Each of the two shifting patterns described can be produced as mirror-inverted variants so that the shifting pattern optionally runs from left to right or from right to left.

Finally, let it be noted that although the invention is particularly well suited for a group transmission with a three-gear manually shifted part, basically it can also be extended to a 5-gear main group. The shifting device according to the invention can also be used in other transmissions.

BRIEF DESCRIPTION OF THE DRAWINGS

To clarify the invention further, the description of a drawing of an example embodiment is attached. The drawing shows:

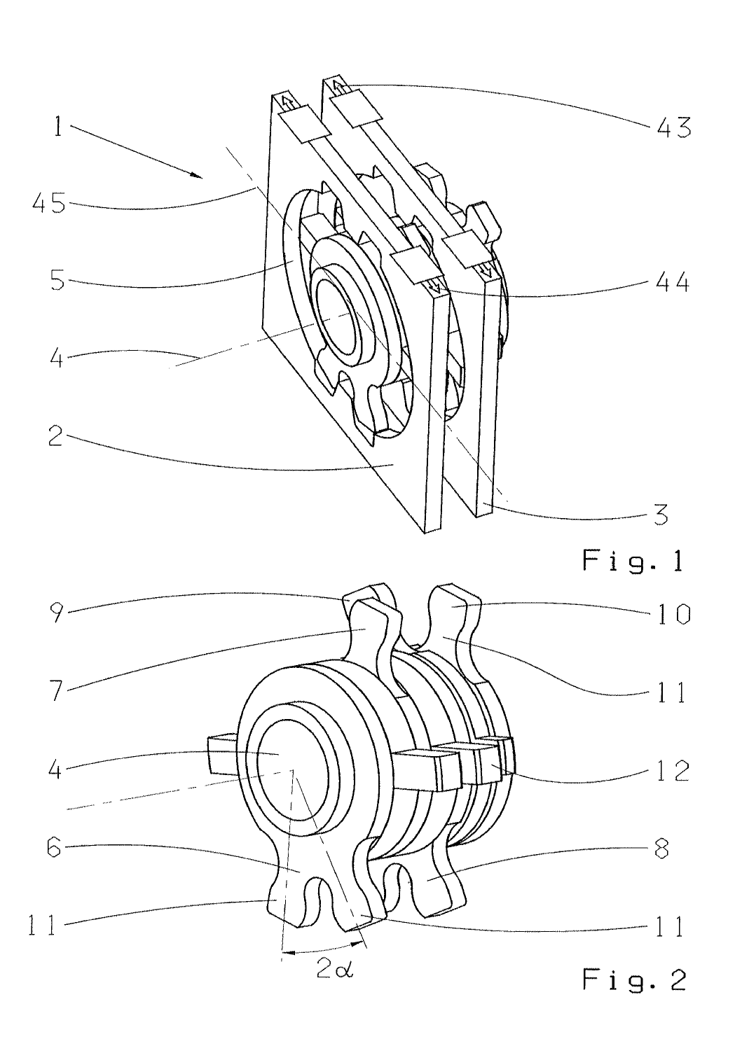

FIG. 1: A shift finger system for a multiple-H shifting device for a multi-group transmission, viewed in perspective,

FIG. 2: An arrangement of shift fingers of the shift finger system,

FIG. 3: A shift finger engaged with a carrier element,

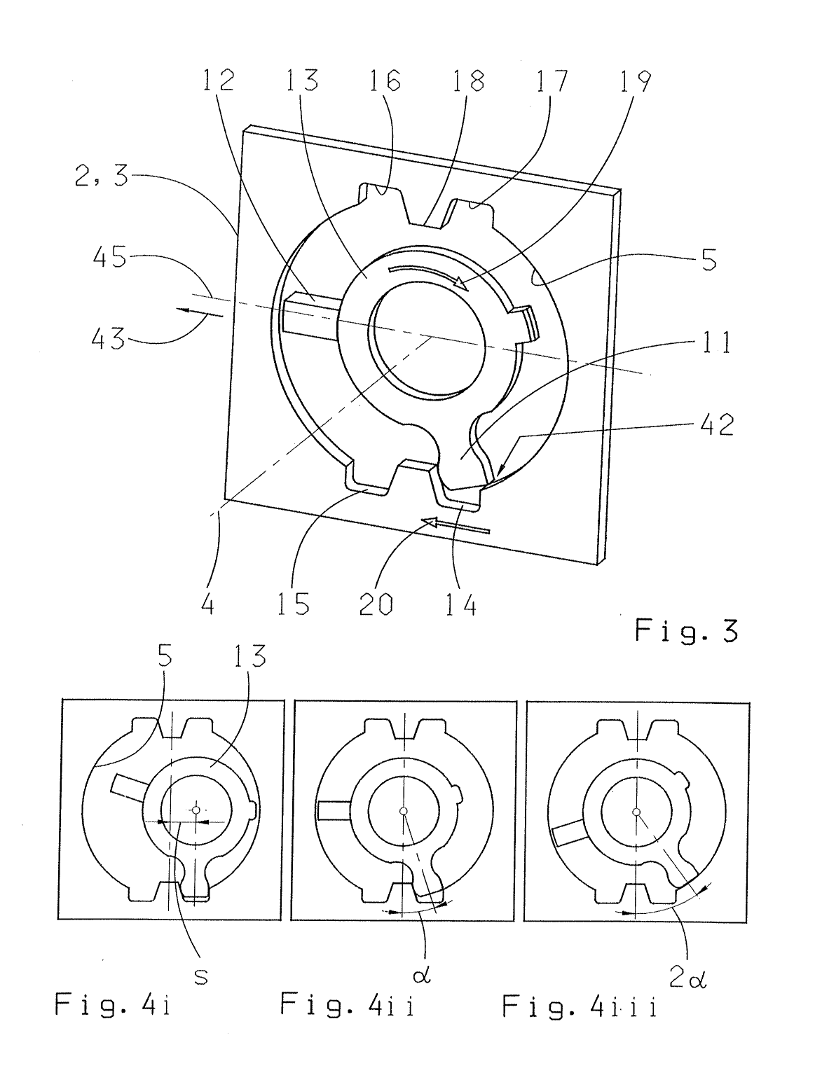

FIGS. 4i, 4ii, 4iii: Three shift positions of the shift finger engaged with the carrier element,

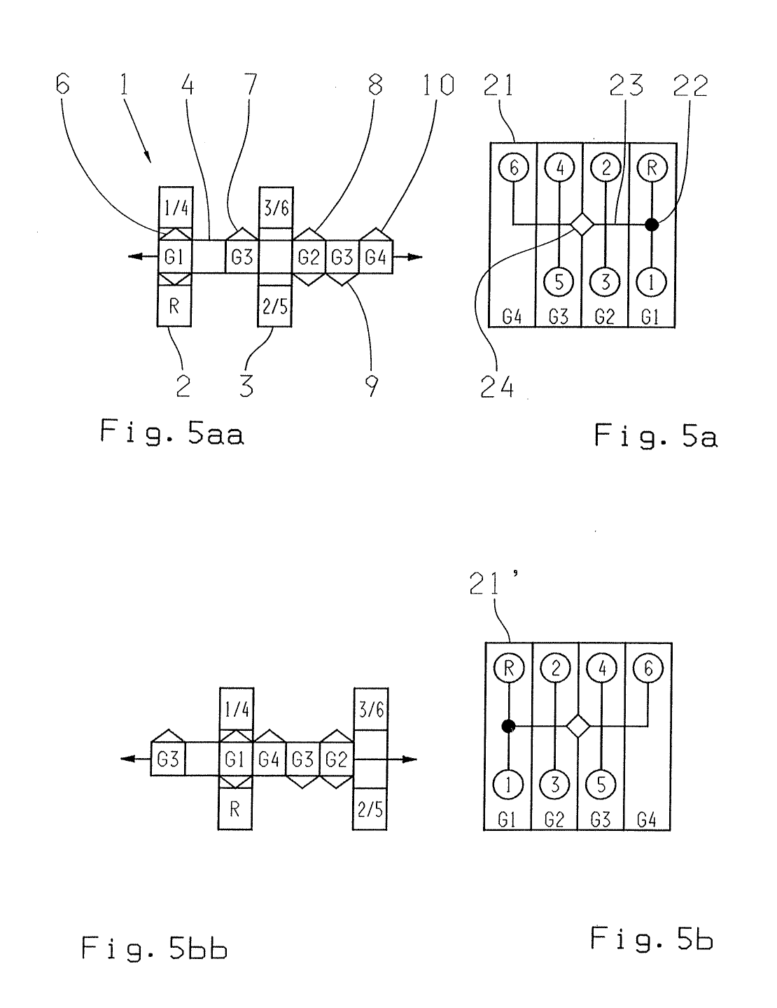

FIGS. 5a, 5aa: A first shifting pattern and an associated actuator scheme,

FIGS. 5b, 5bb: A shifting pattern mirror-inverted relative to the first shifting pattern, and an associated actuator scheme,

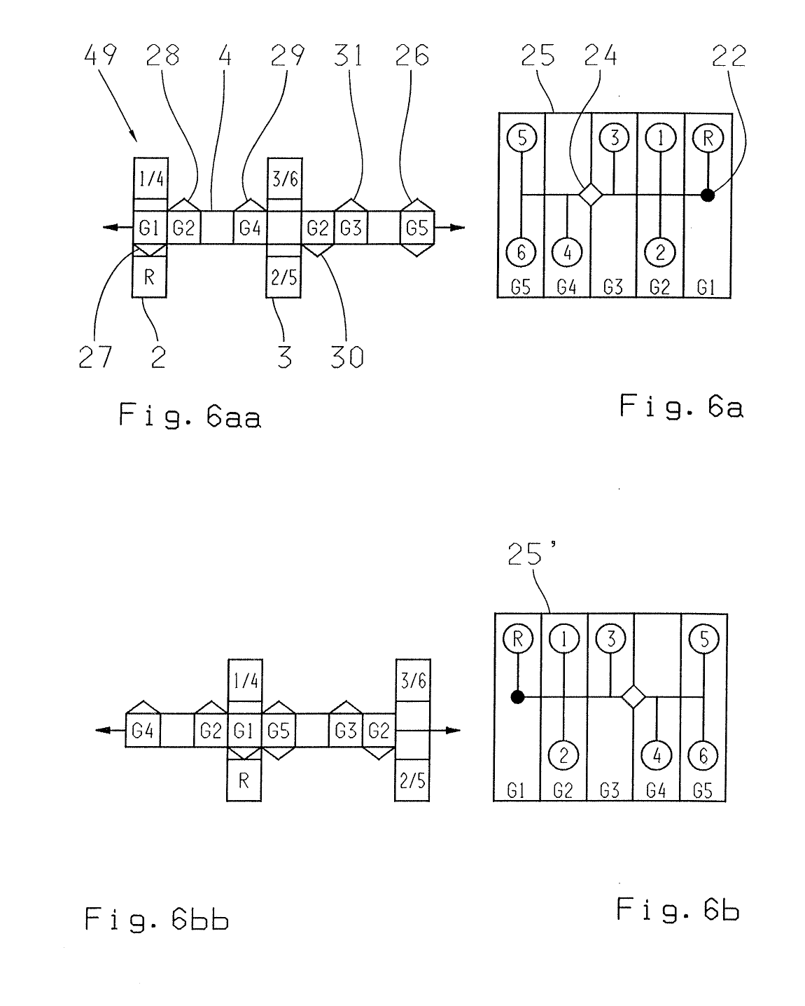

FIGS. 6a, 6aa: A second shifting pattern and an associated actuator scheme,

FIGS. 6b, 6bb: A shifting pattern mirror-inverted relative to the second shifting pattern, and an associated actuator scheme, and

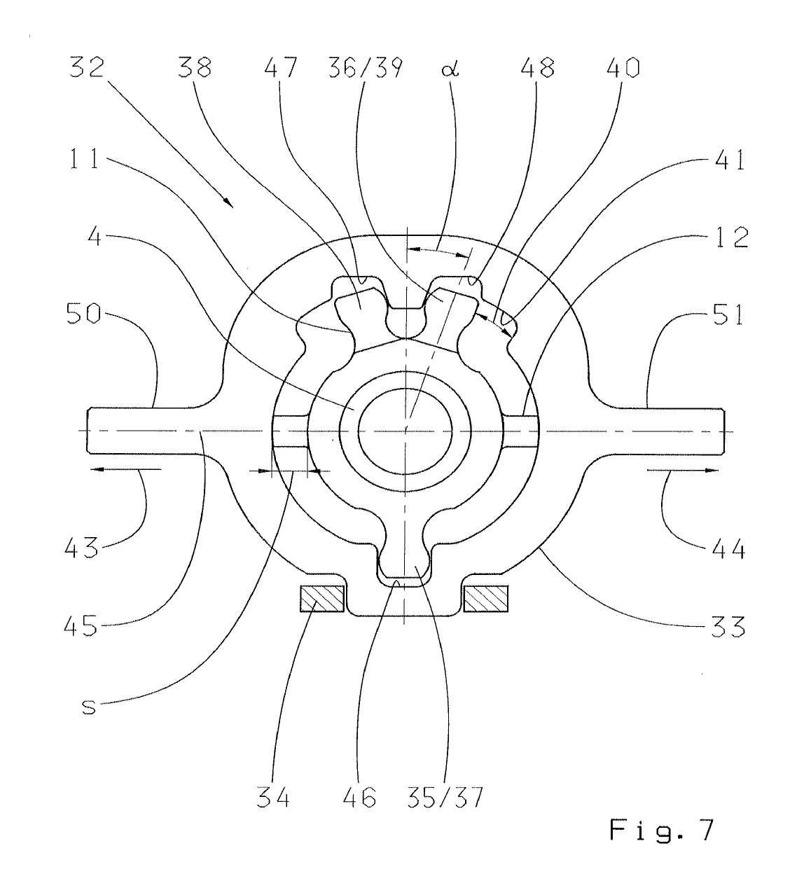

FIG. 7: A second embodiment of a shift finger system for a shifting pattern according to FIG. 5a or 5b, in cross-section.

### DETAILED DESCRIPTION OF THE PREFERRED EMBODIMENTS

Thus, FIG. 1 shows a shift finger system 1 for a multi-group transmission with a manually shifted 3-gear main group of countershaft design and a shiftable, downstream two-stage range group of planetary design, by means of which the three forward gears can be additionally geared on the drive output side.

The transmission comprises a first common synchronous shifting packet for a reverse gear and the first forward gear, and a second synchronous shifting packet for the second and third forward gears. A gearwheel plane of the third forward gear can at the same time function as one of two input constants of an upstream splitter group, so that a total of 12 forward gear ratios can be selected. The same basic transmission structure is known for example from the previously unpublished DE 10 2008 001 200.9, although there with claw shifting packets instead of synchronous packets. Thus, the description below is limited to shift finger systems according to the invention for producing double-H or multiple-H shifting patterns for such a transmission structure.

The shift finger system 1 has two frame-shaped carrier elements 2, 3 or shifting frames provided with openings 5 through which passes a shift finger shaft 4 which is merely indicated in FIG. 1. Not shown are shift rods arranged laterally on the carrier elements 2, 3 or shifting frames, which in the usual way engage by means of shifting forks in sliding sleeves of the synchronous shifting packets. At the tops of the frames are indicated the gears that can be actuated by each carrier element 2, 3 as well as the two shifting directions 43, 44 in which the carrier elements 2, 3 can be displaced along their displacement axis 45. On the shift finger shaft 4 a plurality of shift fingers 6, 7, 8, 9, 10 are arranged in a rotationally fixed manner (see FIG. 2), which serve to actuate the carrier elements 2, 3.

The arrangement of the shift fingers on the shift finger shaft 4 is shown in FIG. 2. Viewed in perspective, these consist of a first double shift finger 6, a first single shift finger 7, a second double shift finger 8, a second single shift finger 9, and a third single shift finger 10. The double shift fingers 6, 8 have in each case two radially outward-projecting finger elements 11 located in a plane, which enclose an angle of 2α such that the bisector of the angle is perpendicular to the displacement axis 45 of the carrier elements 2, 3. The single shift fingers 7, 9, 10 each have one such finger element 11 arranged at an angle α or −α. Furthermore, associated with the shift fingers 6, 7, 8, 9, 10 are neutral fingers 12, which hold the carrier element(s) in a neutral position in the unengaged condition, i.e. in a free-running condition 42 (FIGS. 3 and 4i, 4ii and 4iii).

To clarify the carrier element engagement, FIG. 3 shows a carrier element 2, 3 with a single shift finger 13. The carrier element 2, 3 has four recesses 14, 15, 16, 17 arranged as two opposite pairs, so that they correspond with the finger elements 11. The recess pairs 14/15 and 16/17 are respectively separated from one another by a projection 18 extended radially inward, which serves as a working contact surface for the finger element 11 concerned. The arrows 19, 20 indicate a rotational direction of the shift finger shaft 4 and an associated displacement of the carrier element 2, 3 in the shifting direction 43 (FIG. 1). An engagement in the upper recesses 16, 17 rotates the shifting direction antithetically to an engagement in the lower recesses 14, 15 while maintaining the rotational direction of the shift finger shaft 4 opposite to the shifting direction 43.

Three possible shift positions of the arrangement in FIG. 3 are shown in FIGS. 4i, 4ii and 4iii. The shift positions can be set by first axially displacing the shift finger shaft 4 so that the shift finger 13 is positioned axially in the carrier element opening 5 and the finger element 11 in the recess 14. In teh position shown in FIG. 4i, by rotating the shift finger shaft 4 the carrier element 2, 3 is displaced by a shift path s relative to a neutral position as shown in FIG. 4ii, so that the finger element 11 is perpendicular to the displacement axis 45 of the carrier element 2, 3. In this position an associated gear is engaged. In this position the neutral finger 12 is substantially distant from the boundary of the opening 5.

In the neutral position as shown in FIG. 4ii the shift finger 13 is turned back through a shifting angle α. This position corresponds to a starting position for the free movement 42 which is opposite to the shifting direction or gear engagement direction. In this position the neutral finger 12 is only a very small distance away from the boundary of the opening 5 of the carrier element 2, 3. From this position the neutral finger 12 holds the carrier element 2, 3 fixed and so prevents any unintended entrainment of the carrier element 2, 3. In an end position as shown in FIG. 4iii of the free movement zone the shift finger 13 is turned away from the gear engagement position by the double angle 2α.

FIG. 5a shows a shifting pattern 21 according to the invention and an associated actuator scheme as shown in FIG. 5aa. The shifting pattern 21 corresponds to the shift finger system 1 shown in FIGS. 1 and 2. At the moment depicted a shift lever (not shown) is at a shift position 22 in a first shifting gate G1. Correspondingly, the double shift finger 6 is positioned in the first carrier element 2. The shift fingers 6, 7, 8, 9, 10 are in each case shown with the shifting gates G1, G2, G3, G4 in which they are actuated. The arrow-points at shifting gate positions G1, G2, G3, G4 in FIG. 5aa show the directions in which the carrier elements 2, 3 can be pushed by the respective shift fingers 6, 7, 8, 9, 10.

In the shifting pattern 21 shifting through the gears takes place in accordance with the following scheme:

In gate G1 the reversing gear R and the first forward gear are engaged by means of the first double shift finger 6. Then the shift lever is moved in a selector gate 23 in the selection direction toward gate G2. In gate G2 the second and third gears are engaged by means of the second double shift finger 8, which engages in the second carrier element 3 by virtue of an axial displacement of the shift finger shaft 4. The gears of gates G1 and G2 are each shifted by a common synchronous packet. In the selection direction after gate G3, by switching the range group a shift 24 of the gear range takes place from the lower gears one to three, to the higher gears four to six.

In gate G3 the shifting direction in the transmission is reversed so that the further shifts can be carried out in the logical gear sequence. Thus, the single shift fingers 7, 9, 10 shifted in the next gates G3 and G4 correspond with the upper recesses 16, 17 of the carrier elements, 2, 3 in contrast to the double shift fingers 6, 8, which in the first two gates G1 and G2 co-operate with the lower recesses 14, 15.

The fourth gear is engaged in shifting gate G3 by means of the first single shift finger 7, since that single shift finger 7 engages in the upper recess 17 of the first carrier element 2. The fifth gear is engaged in the same shifting gate G3 by means of the second single shift finger 9, in that this single shift finger 9 engages in the other upper recess 16, but that of the second carrier element 3. Although they are in the same shifting gate G3, the gears four and five are controlled by different synchronous packets. Finally after a further selection movement the sixth gear is engaged in shifting gate G4, for which the third single shift finger 10 again engages in the first upper recess 17, now still that of the second carrier element 3.

FIG. 5b shows a shifting pattern 21 arranged mirror-inverted relative to the shifting pattern 21. The shifting sequence shown in FIG. 5bb takes place analogously to the manner described above, but with an adapted actuator scheme with another axial displacement sequence of the shift finger shaft 4.

FIGS. 6a and 6aa show a shifting pattern 25 according to a second variant which requires one double shift finger 26 and five single shift fingers 27, 28, 29, 30, 31, i.e. a shift finger system 49 with a total of six shift fingers. These six shift fingers 26, 27, 28, 29, 30, 31 are actuated in five shifting gates G1, G2, G3, G4, G5. In gate G1 the reversing gear is engaged. In gate G2, in this case there is already a shifting direction reversal and different synchronous packets are activated. In the next gate G3 the third forward gear is now engaged. In the selection direction the range shift 24 then takes place. In gate G4 only the fourth forward gear is engaged. In the fifth shifting gate G5, finally, the fifth and the sixth gears are engaged by means of the common shifting packet of gears two and three with the double shift finger 26. The shifting pattern 25 requires six shift fingers instead of the five shift fingers for shifting patterns 21, 21′, but needs only one double shift finger.

FIG. 6b again shows a shifting pattern 25′ mirror-inverted relative to shifting pattern 25. The shifting sequence shown in FIG. 6bb takes place analogously with an adapted axial displacement sequence of the shift finger shaft 4.

Finally, FIG. 7 shows a further shift finger system 32, which can be used for the shifting pattern 21, 21′ in FIGS. 5a and 5b. The shift finger system 32 comprises two carrier elements 33, 34, the second carrier element being only indicated in FIG. 7, and five single shift fingers 35, 36, 37, 38, 39 which, in FIG. 7, are positioned in a particular sequence one after another. The carrier elements 33 and 34 have in each case one lower recess 46 and two upper recesses 47, 48, which correspond with appropriate finger elements 11 of the single shift fingers 35, 36, 37, 38, 39, a limited free range 40 being provided for the upper engagement in the form of a free movement contour 41 following on from the recesses 47, 48 in the shifting direction 43, 44. The lower recesses 46 are perpendicular to the displacement axis 45 while the upper recesses are positioned obliquely relative to it at an angle α. In FIG. 7 two lateral shift rods 50, 51 are also indicated, which are connected to the carrier element 33.

The five single shift fingers 35, 36, 37, 38, 39 are actuated in the four shifting gates G1, G2, G3, G4 by alternating axial displacements and rotations of the shift finger shaft 4 in such manner that an actuator scheme is again produced which matches the logical multiple-H shifting pattern 21, 21′, wherein instead of double shift finger swiveling comparatively more displacement movements are carried out.

### List of Indexes

1 Shift finger system
2 Carrier element
3 Carrier element
4 Shift finger shaft
5 Opening
6 Double shift finger
7 Single shift finger
8 Double shift finger
9 Single shift finger
10 Single shift finger
11 Finger element
12 Neutral finger
13 Single shift finger
14 Recess
15 Recess
16 Recess
17 Recess
18 Projection
19 Arrow
20 Arrow
21, 21′ Shifting pattern
22 Shifting position
23 Selector gate
24 Range shift
25, 25′ Shift pattern
26 Double shift finger
27 Single shift finger
28 Single shift finger
29 Single shift finger
30 Single shift finger
31 Single shift finger
32 Shift finger system
33 Carrier element
34 Carrier element
35 Single shift finger
36 Single shift finger
37 Single shift finger
38 Single shift finger
39 Single shift finger
40 Free movement
41 Free movement contour
42 Free movement
43 Shifting direction
44 Shifting direction
45 Displacement axis
46 Recess
47 Recess
48 Recess
49 Shift finger system
50 Shifting rod
51 Shifting rod
G1 Shift gate
G2 Shift gate
G3 Shift gate
G4 Shift gate
G5 Shift gate
R Reverse gear
s Shifting displacement
α Shifting angle

1-16. (canceled)

17. A shifting device for a multi-group transmission in which the multi-group transmission has at least one manually shifted main group, with an odd number of forward gears, and a range group for shifting between two gear ranges, with a shift lever with which a shifting pattern (21, 21′, 25, 25′) being associated, the shifting pattern comprising a selector gate (23) and a plurality of shifting gates (G1, G2, G3, G4, G5) with gears opposite one another, by which a shift finger shaft (4) that carries a plurality of shift fingers (6-10, 13, 26-31, 35-39) being rotated about its longitudinal axis and being axially displacable such that, depending on movement of the shift lever for shifting a gear, a shift finger (6-10, 13, 26-31, 35-39) engages in an associated carrier element (2, 3, 32, 34) to actuate a shifting packet coupled by a shifting rod (50, 51) to the carrier element (2, 3, 33, 34) in an appropriate shifting direction (43, 44), and with mechanical means for reversing the shifting direction (43, 44) and for shifting gears that are opposite one another in a shifting gate (G1, G2, G3, G4, G5) and that are controlled by different shifting packets,
a shift finger system (1, 32, 49) being provided which comprises the plurality of shift fingers (6-10, 13, 26-31, 35-39) in a form of single shift fingers (7, 9, 10, 13, 27-31, 35-39), each with one finger element (11), and where necessary in a form of double shift fingers (6, 8, 26), each with two finger elements (11) that are located in a plane and arranged offset from one another, and associated carrier elements (2, 3, 33, 34) which have corresponding recesses (14-17, 46-48) for engaging the single shift fingers (7, 9, 10, 13, 27-31, 35-39) and if applicable the double shift fingers (6, 8, 26), by which the carrier elements (2, 3, 33, 34) are actuatable in at least one of opposite shifting directions (43, 44) and a reversable particular shifting direction (43, 44), such that the gears of the two gear ranges are shifted in a multiple-H shifting pattern (21, 21′, 25, 25′) in sequence one after another by alternating shift lever movements, and the two gear ranges are changable by a selection movement of the shift lever.

18. The shifting device according to claim 17, wherein the main group has three forward gears and the shifting pattern is a multiple-H shifting pattern (21, 21′, 25, 25′) and a which is realized with a shift finger system (1, 32, 49) having two carrier elements (2, 3, 33, 34).

19. The shifting device according to claim 17, wherein the main group is a three-step main group and is associated with a first shifting pattern (21, 21′) having a first shifting gate (G1) in which a reversing gear (R) and a first forward gear are shiftable by a common shifting packet, after a first selection movement of the shift lever into a second shifting gate (G2), a second forward gear and a third forward gear are shiftable by a common shifting packet, after a second selection movement of the shift lever with a range change (24) and a shifting direction reversal in a third shifting gate (G3), a fourth forward gear and a fifth forward gear are shiftable by different shifting packets, and after a third selection movement of the shift lever in a fourth shifting gate (G4), a sixth forward gear is engagable.

20. The shifting device according to claim 19, wherein a shift finger system (1) of the first shifting pattern (21, 21′) comprises a respective double shift finger (6, 8) for the first and the second shifting gates (G1, G2) and a total of three single shift fingers (7, 9, 10) for the third and the fourth shifting gates (G3, G4).

21. The shifting device according to claim 19, wherein a shift finger system (32) of the first shifting pattern (21, 21′) comprises, for the first and the second shifting gates (G1, G2), a single shift finger (35, 37) which in an actuation position is perpendicular to a displacement axis (45) of the carrier element (33, 34) and is directed underneath the displacement axis (45) for a lower engagement, and for the third and the fourth shifting gates (G3, G4), a total of three shift fingers (36, 38, 39) which, in an actuation position, are positioned obliquely to the displacement axis (45) of the carrier element (33, 34) and are arranged above the displacement axis (45) for an upper engagement.

22. The shifting device according to claim 21, wherein toward the shifting direction (43, 44), at least one recess (47, 48) for the upper engagement merges into a free movement contour (41) which delimits a free movement (40).

23. The shifting device according to claim 17, wherein the main group is a three-step main group and is associated with a second shifting pattern (25, 25′) with a first shifting gate (G1) in which a reverse (R) is engagable, after a first selection movement of the shift lever with a shifting direction reversal, a first forward gear and a second forward gear are engagable by different shifting packets in a second shifting gate (G2), after a second selection movement of the shift lever, a third forward gear is engagable in a third shifting gate (G3), after a third selection movement of the shift lever with a range change (24), a fourth forward gear is engagable in a fourth shifting gate (G4), and after a fourth selection movement of the shift lever, a fifth forward gear and a sixth forward gear are engagable by a common shifting packet in a fifth shifting gate (G5).

24. The shifting device according to claim 23, wherein a shift finger system (49) of the second shifting pattern (25, 25′) comprises a double shift finger (26) for the fifth shifting gate (G5) and for the first, the second, the third and the fourth shifting gates (G1, G2, G3, G4) a total of five single shift fingers (27-31).

25. The shifting device according to claim 17, wherein the shift fingers (6-10, 13, 26-31, 35-39) are in the form of rings fixed on the shift finger shaft which are connected integrally to the finger elements (11) such that the finger elements (11) project radially outward as studs, and the carrier elements (2, 3, 33, 34) have circular openings (5) for holding the shift finger shaft (4), in which the recess (14-17, 46-48) for engaging the finger elements (11) are formed.

26. The shifting device according to claim 17, wherein at least one carrier element (2, 3, 33, 34) comprises at least one recess (14, 15, 46) arranged below a displacement axis (45) of the carrier element (2, 3, 33, 34) and a second recess (16, 17, 47, 48) arranged above the displacement axis (45) of the carrier element (2, 3, 33, 34), for shifting direction reversal.

27. The shifting device according to claim 17, wherein at least one carrier element (2, 3) has four recesses (14, 15, 16, 17) for a double shift finger (6, 8, 26), with two recess pairs (14/15, 16/17) respectively above and below a displacement axis (45) of the carrier element (2, 3) opposite one another such that, by engagement of the double shift finger (6, 8, 26) in one of the two recess pair (14/15, 16/17), rotation of the shift finger shaft (4) to the right or to the left moves the carrier element (2, 3) in one or the other shifting direction (43, 44), and by engagement of the double shift finger (6, 8, 26) in the other one of the two recess pairs (14/15, 16/17), rotation of the shift finger shaft (4) to the right or to the left moves the carrier element (2, 3) in one or the other shifting direction (43, 44) in a converse sense.

28. The shifting device according to claim 17, wherein adjacent recesses (14/15, 16/17) are separated by a tooth-like projection (18) extending radially inward for acting in a respective shifting direction (43, 44).

29. The shifting device according to claim 17, wherein the carrier element comprises a neutral section (42) in a particular shifting direction (43, 44).

30. The shifting device according to claim 17, wherein at least one neutral finger (12), for securing a neutral position of a carrier element (2, 3, 33, 34) in a disengaged condition, is arranged on the shift finger system (1, 32, 49).

31. The shifting device according to claim 17, wherein the shifting patterns (21, 21′, 25, 25′) are in each case realized as mirror-inverted variants.

32. The shifting device according to claim 17, wherein the shifting device is designed for a 12-gear multi-group transmission with a three-step main group, a two-step range group and a two-step splitter group, such that the gears that are actuatable by virtue of a multiple-H shifting pattern (21, 21′, 25, 25′) are devisable into two gear ratio steps by shifting between two input constants of the splitter group by a separate operating element.

33. A shifting device for a multi-group transmission having at least one manually shifted main group and a range group, the main group having an odd number of forward gears and the range group having two gear ranges, a shift lever being movable in a shifting pattern (21, 21′, 25, 25′) for shifting between gears of the forward gears in the two gear ranges, the shifting device comprising:
a shift finger shaft (4) supporting a plurality of shift fingers (6-10, 13, 26-31, 35-39) axially displacable along and rotatable about a longitudinal axis by movement of the shift lever in the shifting pattern (21, 21′, 25, 25′) comprising a selector gate and a plurality of shifting gates (G1, G2, G3, G4, 05);
a plurality of carrier elements (2, 3, 32, 34) being coupled, via shifting rods (50, 51), to associated shifting packets, the shift fingers (6-10, 13, 26-31, 35-39) being associated with the carrier elements (2, 3, 32, 34) such that, depending on the movement of the shift lever in the selector gate and the plurality of shifting gates, the shift fingers (6-10, 13, 26-31, 35-39) engage and bias the associated carrier elements (2, 3, 32, 34) in a first shift direction or an opposite second shift direction (43, 44) to actuate the shift packets that are opposite one another in the associated shifting gate (G1, G2, G3, G4, G5);
the plurality of shift fingers (6-10, 13, 26-31, 35-39) comprising single shift fingers (7, 9, 10, 13, 27-31, 35-39) and double shift fingers (6, 8, 26), each of the single shift fingers (7, 9, 10, 13, 27-31, 35-39) comprising a single finger element (11) and each of the double shift fingers (6, 8, 26) comprises two finger elements (11), the two finger elements (11) of the double shift fingers (6, 8, 26) being located in a plane and extending radially offset from each other; and
each of the plurality of carrier elements (2, 3, 32, 34) having either one or two recesses (14-17, 46-48) depending on whether the carrier element is associated with either one of the single shift fingers or one of the double shift fingers, the recesses (14-17, 46-48) receiving the corresponding finger elements (11) and are actuated thereby in the one shift direction or the opposite shift direction (43, 44) so that the gears in the two gear ranges are shifted sequentially in a multiple-H shifting pattern (21, 21′, 25, 25′) one after another by alternating the movements of the shift lever, and a shift between the two gear range being produced by a selection movement of the shift lever.
